(19) United States
(12) Patent Application Publication
(10) Pub. No.: US 2011/0227295 A1
(43) Pub. Date: Sep. 22, 2011

(54) TWO-MATERIAL COMPOSITE GASKET

(75) Inventors: Takeshi Watanabe, Kanagawa (JP); Manshu Kameike, Kanagawa (JP)

(73) Assignee: NOK CORPORATION, Tokyo (JP)

(21) Appl. No.: 13/130,622

(22) PCT Filed: Nov. 24, 2009
(86) PCT No.: PCT/JP2009/069769

§ 371 Date: May 23, 2011

(30) Foreign Application Priority Data
Nov. 25, 2008 (JP) 2008-299406

(51) Int. Cl. F02F 11/00; F16J 15/06; F16J 15/02; F16J 15/10

(52) U.S. Cl. 277/591; 277/644; 277/641

(57) ABSTRACT

Disclosed is a two-material composite gasket, preferably a two-material composite annular gasket, for sealing a gap between two opposing surfaces, one of the surfaces having a concave gap portion, which is to be sealed by the gasket, the gasket having an oblong cross-sectional shape and having projections on the top end and bottom end thereof, the gasket including an upper low-hardness elastomer molded part formed of vulcanized rubber having a Shore A hardness of 5 to 35, a lower high-hardness elastomer molded part formed of vulcanized rubber having a Shore A hardness of 45 to 80, and a parting line bonding the low-hardness elastomer molded part and the high-hardness elastomer molded part, the parting line being positioned so that the height of the low-hardness elastomer molded part is 5 to 40% of the height of the entire gasket. The two-material composite gasket enables three-surface simultaneous sealing of a gap formed by three members, as typified in a joint structure composed of a cylinder block, a cylinder head, and a chain cover of an automobile engine.

### TECHNICAL FIELD

The present invention relates to a two-material composite gasket. More particularly, the present invention relates to a two-material composite gasket that can be effectively used to simultaneously seal three surfaces of members of an automobile engine and the like.

### BACKGROUND ART

Relatively large-sized gaskets are used for inlet manifolds, filter blankets, cylinder head covers, cam covers, and the like of automobile engines. Such a gasket is configured to seal hermetically a gap between two members, one of which has a groove and the other of which has a flat part, by inserting the gasket in the groove. However, since the depth of the groove is affected by tolerance induced during processing of the groove or assembling, the entire groove does not necessarily have a uniform depth (see Patent Document 1).

In an automobile engine, two members of the engine, i.e., an engine cylinder block and a cylinder head, are hermetically sealed to each other through a cylinder head gasket, and a chain cover is provided to integrate the engine with a power transmission mechanism attached to these members. Since the chain cover is disposed orthogonally across the joint surface of the block and the head, an irregular three-surface simultaneous sealing function is required at the intersection of mating surfaces of these members.

FIG. 9 is a perspective view showing one usage embodiment for simultaneous sealing of three surfaces, in which an engine seal gasket is applied. In the automobile engine, two members, i.e., a cylinder block 21 for converting explosive combustion of fuel to a reciprocating movement of a piston, and a cylinder head 22 for converting the piston reciprocating movement to a rotational movement, are hermetically sealed to each other through a cylinder head gasket 23, which is a sealing member for maintaining the airtightness between the cylinder block 21 and the cylinder head 22.

In order to integrate a power transmission mechanism attached to these members with the engine, a chain cover 24 is provided a part to accommodate a gear shift mechanism for transmitting the rotational movement converted by the cylinder head to the outside of the engine. Since the chain cover 24 is disposed orthogonally across the joint surface of the cylinder block 21 and the cylinder head 22, a gasket 26 is required as a sealing member, which is required to have an irregular three-surface simultaneous sealing function, at the intersection of the mating surfaces of these members, that is, a three-point sealing part 25.

As a sealing material capable of reliably sealing a three-surface mating part even when respective thermal expansion amounts of a cylinder head, a cylinder block, and a chain cover are different, Patent Document 2 proposes a sealing material for sealing a three-surface mating part, the sealing material comprising a first sealing piece for sealing a gap between the lower surface of a cylinder head and the upper surface of a cylinder block; a second sealing piece projecting from the rear side of the first sealing piece toward between the front side end of the cylinder head lower surface and the front side end of the cylinder block upper surface, for sealing a gap between the front side end of the cylinder head lower surface and the front side end of the cylinder block upper surface; a first rib for obliquely connecting the upper part of the rear side of the first sealing piece and the upper surface of the second sealing piece; and a second rib for obliquely connecting the lower part of the rear side of the first sealing piece and the lower surface of the second sealing piece. In this proposal, the sealing material is formed of the first sealing piece and the second sealing piece.

Moreover, as a gasket material for sealing the joint part of three members of an engine, i.e., a cylinder block, a cylinder head, and a front cover, Patent Document 3 proposes a gasket structure for use in the joint part of the three members. In the gasket structure, a head gasket is provided between the cylinder block and the cylinder head, and a front cover gasket is provided between the cylinder block and cylinder head, and the front cover at a right angle with respect to the head gasket. The head gasket is positioned slightly recessed from the end surface of the side of the three-member joint part. The three-member joint part of the front cover gasket projects at right angles to form an approximately cross-shaped part, and the contact surface of the approximately cross-shaped part with the head gasket partially projects to form a convex part. In this proposal, it is necessary to specify the position of the mating surface, and airtightness in the three-point sealing part is insufficient because of the variation in the size due to the tolerance of the three members.

The present applicant has previously proposed a gasket that can seal a gap between two members in such a manner that the gasket is inserted in an insertion groove provided in one of the two members, and compressed by the two members. The portion of the gasket on the high-pressure side is formed so as to be more easily compressed than the portion of the gasket on the low-pressure side, and the side surface of the gasket is inclined so that the central portion of the gasket body is bent to project toward the low-pressure side region when the gasket is compressed by the two members (see Patent Document 4).

An embodiment of this proposed invention is a gasket for sealing a gap between two opposing surfaces, one of the surfaces having a concave gap portion, which is to be sealed by the gasket, the gasket having an oblong cross-sectional shape to be seal a gap and having sealing projections on the top end and bottom end thereof. However, as gasket materials, for example, acrylic rubber, nitrile rubber, fluororubber, and other rubber materials having a rubber hardness (Durometer A: JIS K6253) of 40 to 70, or thermoplastic elastomers are singly used.

### PRIOR ART DOCUMENT

### Patent Document

Patent Document 1: JP-A-2002-276462
Patent Document 2: JP-A-2008-19793
Patent Document 3: JP-B-3572201
Patent Document 4: JP-A-2007-255671
Patent Document 5: WO 2004/031315 A1

### OUTLINE OF THE INVENTION

### Problem to be Solved by the Invention

For example, a joint structure composed of three members, i.e., a cylinder block, a cylinder head, and a chain cover, has a problem that an irregular gap formed in the mating surface cannot be sealed with a gasket alone. At present, silicone-type liquid rubber is used to seal such a gap in the assembling of the joint structure; however, silicone-type liquid rubber is not used as a sealing material that can generate surface pressure, but is merely used as a pad to block the gap portion. Accordingly, a problem of material degradation (permanent set) occurs after long-term use, causing leakage. Particularly, silicone-type liquid rubber is very vulnerable to degradation by new fuels, such as bioethanol. Moreover, the assembly line includes multiple complex processes (e.g., coating-assembling-drying) and has difficulty in manual correction when in-process defects occur. Another problem is that the management of silicone-type liquid rubber itself is difficult.

An object of the present invention is to provide a gasket for sealing a gap between two opposing surfaces, one of the surfaces having a concave gap portion; particularly a gasket having an oblong cross-sectional shape and having sealing projections on the top end and bottom end thereof. The gasket is used to seal the gap portion, and allows three-surface simultaneous sealing of a gap formed by three members, preferably as typified in a joint structure composed of a cylinder block, a cylinder head, and a chain cover of an automobile engine.

### Means for Solving the Problem

The above object of the present invention can be accomplished by a two-material composite gasket for sealing a gap between two opposing surfaces, one of the surfaces having a concave gap portion, which is to be sealed by the gasket, the gasket having an oblong cross-sectional shape and having projections on the top end and bottom end thereof, the gasket including an upper low-hardness elastomer molded part formed of vulcanized rubber having a Shore A hardness of 5 to 35, a lower high-hardness elastomer molded part formed of vulcanized rubber having a Shore A hardness of 45 to 80, and a parting line bonding the low-hardness elastomer molded part and the high-hardness elastomer molded part, the parting line being positioned so that the height of the low-hardness elastomer molded part is 5 to 40% of the height of the entire gasket.

Preferably, the gasket for sealing a gap between two opposing surfaces is an annular gasket, and the center of the top end and the center of the bottom end of the gasket are each provided with projections.

### Effect of the Invention

The two-material composite gasket of the present invention has the following effects:

(1) The gasket can be effectively used to seal a gap between two opposing surfaces, one of the surfaces having a concave scratch or groove as a gap portion formed in the mating part of the two surfaces.

(2) Since the entire surface of the gasket is configured to be able to seal three surfaces, the gasket allows three-surface simultaneous sealing without specifying the position of the mating surface.

(3) When the gasket is inserted, the high-hardness elastomer molded part of the lower part of the gasket provides sufficient reaction force, and the upper projection of the low-hardness elastomer molded part of the upper part of the gasket effectively blocks and seals an irregular gap portion formed in the mating surface of three members bonded to each other (e.g., a cylinder block, a cylinder head, and a chain cover of an automobile engine), thus allowing airtight sealing.

(4) The use of the gasket as a sealing material does not require multiple complex processes (coating-assembling-drying), as in the use of silicone-type liquid rubber, and improves the problems in product management that occur when silicone-type liquid rubber is used as a sealing material. Additionally, manual correction when in-process defects occur, and maintenance at the time of vehicle inspection and the like can also be facilitated.

### BRIEF DESCRIPTION OF DRAWINGS

FIG. 1 is a longitudinal cross-sectional view showing a basic embodiment of the two-material composite annular gasket of the present invention.

FIG. 2 is a longitudinal cross-sectional view showing another embodiment of the two-material composite annular gasket of the present invention.

FIG. 3 is a partial plane view of the two-material composite annular gasket.

FIG. 4 is a longitudinal cross-sectional view of another two-material composite annular gasket having a different cross-sectional shape.

FIG. 5 is a longitudinal cross-sectional view showing an insertion state of the two-material composite annular gasket shown in FIG. 1.

FIG. 6 is a longitudinal cross-sectional view showing an insertion state of the two-material composite annular gasket shown in FIG. 4.

FIG. 7 is a perspective view showing a state of the two-material composite annular gasket of the present invention inserted in an insertion groove against a housing having a gap portion.

FIG. 8 shows cross-sectional views indicating a leakage state (a) and a sealed state (b) when the gasket is inserted in the insertion groove.

FIG. 9 is a perspective view showing a state of the two-material composite annular gasket used as an engine seal gasket, which is a usage example for three-surface simultaneous sealing.

### EMBODIMENTS FOR CARRYING OUT THE INVENTION

A two-material composite gasket, preferably a two-material composite annular gasket according to the present invention can seal a gap between two opposing surfaces, one of the surfaces having a concave gap portion, which is to be sealed by the gasket. The gasket has an oblong cross-sectional shape and has projections in the center of the top end and the center of the bottom end thereof. The upper part of the gasket is formed of a low-hardness elastomer, and the lower part of the gasket is formed of a high-hardness elastomer. The form of the annular gasket may be a circle, square, or the like, and the gasket may take any form.

Here, the low-hardness elastomer has a Shore A hardness of 5 to 35, preferably 10 to 20, in order to achieve excellent gap-filling properties. The high-hardness elastomer has a Shore A hardness of 40 or more, preferably 45 to 80, because it is a support generating reaction force, and is required to have hardness sufficient for enabling hermetic sealing of an insertion groove, on the other hand. Moreover, the high-hardness elastomer, which is a support generating reaction force, is preferably resistant to permanent set (compression set). The rubber hardness is adjusted by controlling the amount of filler and cross-linking density. For example, the hardness is increased by increasing the amount of filler or cross-linking density. The Shore A hardness was measured according to Type A Durometer of JIS K6253 corresponding to ISO 7619-1.

When the gasket is inserted, the lower high-hardness elastomer molded part provides sufficient reaction force, and the upper projection of the low-hardness elastomer molded part blocks an irregular gap portion formed in the mating surface of three members that are bonded to each other, while increasing surface pressure, thereby performing hermetic sealing. On the other hand, the lower projection enhances the sealing properties of the lower part of the gasket.

The projection in the upper center of the low-hardness elastomer molded part has a curvature. Similarly, the projection in the lower center of the high-hardness elastomer molded part has a curvature. The projections having a curvature achieve high surface pressure, while reducing deformation during compression. In terms of strain relaxation and improvement in gap-filling properties for the three-surface mating member, the curvature is preferably about 0.3 to 0.5.

The cross-sectional area of the upper gasket formed of low-hardness elastomer must be designed to have a size larger than the cross-sectional area of a gap portion formed by three surfaces to be sealed so that it can certainly fill and enter into the gap portion. Moreover, the height of the cross-sectional surface of the lower gasket formed of high-hardness elastomer must be greater than the height of the cross-sectional surface of the low-hardness elastomer molded part of the upper gasket, because it is necessary to achieve sufficient reaction force required for the low-hardness elastomer molded part to enter into the gap portion formed by three surfaces.

Conversely, when the gasket has a uniform cross-sectional area, and the height of the high-hardness elastomer molded part is lower than the height of the low-hardness elastomer molded part, sufficient reaction force cannot be obtained, while buckling is likely to occur. Accordingly, from the viewpoint of the generation of sufficient reaction force and the prevention of buckling, the height of the low-hardness elastomer molded part is preferably about 5 to 40% of the cross-sectional height of the entire two-material composite gasket. When this value is less than about 5%, the low-hardness elastomer can insufficiently enter into the gap portion, failing to perform complete sealing.

Generally, various engine annular gaskets are designed to have an oblong cross-sectional shape with a height of about 5 to 20 mm and a width of about 1.5 to 6 mm. In the two-material composite annular gasket of the present invention, the aspect ratio (width d₀/height h₀) is set within the range of 0.2 to 0.3. Regarding the width of the cross-section of the gasket, both side surfaces are preferably inclined so that the width becomes gradually narrower toward the lower edge of the lower high-hardness elastic part from the upper low-hardness elastic part. Such structure enhances the reaction force characteristics of the lower high-hardness elastic part, and ensures transfer of the reaction force to the upper low-hardness elastic part, gap-filling properties, and support of the upper low-hardness elastic part.

At the interface between the low-hardness elastomer molded part and the high-hardness elastomer molded part, these parts are bonded to each other in terms of hermetical sealing performance. Although they may be bonded to each other by an adhesive, vulcanization bonding is preferred in terms of molding and peel strength. Moreover, in terms of the peel strength of vulcanized products, the low-hardness elastomer and the high-hardness elastomer are preferably the same type of elastomer having the same crosslinked structure. Specific examples thereof include acrylic rubber, silicone rubber, fluororubber, and other elastomers having excellent oil resistance, heat resistance, cold resistance, and chemical resistance, in terms of the functionality of gaskets for use in the vicinity of an engine. Furthermore, for example, a cured product of a composition comprising (A) an acrylic polymer having at least one alkenyl group capable of undergoing hydrosilylation reaction, (B) a hydrosilyl group-containing compound curing agent, and (C) a hydrosilylation catalyst as essential components can also be used (see Patent Document 5).

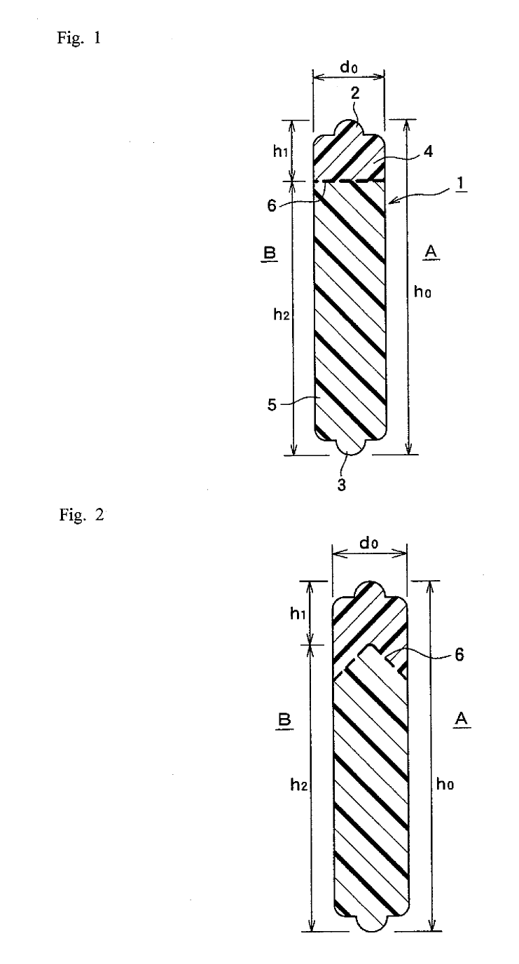

FIG. 1 is a longitudinal cross-sectional view showing a basic embodiment of the two-material composite annular gasket of the present invention. The annular gasket 1 having an oblong cross-sectional shape has an upper projection 2 in the center of the top end, and a lower projection 3 in the center of the bottom end. A low-hardness elastomer molded part 4 and a high-hardness elastomer molded part 5 are bonded to each other by vulcanization bonding in a parting line 6.

In FIGS. 1, 2, and 4, Sign A indicates an internal surface, and Sign B indicates an external surface.

The parting line bonding the low-hardness elastomer molded part and the high-hardness elastomer molded part is positioned so that the height (h₁) of the low-hardness elastomer molded part is about 40% or less, preferably about 5 to 40%, more preferably about 15 to 40%, with respect to the height (10 of the entire gasket, as described above.

Moreover, the parting line is not flat, but is preferably designed so that the upper low-hardness elastomer molded part side has a concave surface, and the lower high-hardness elastomer molded part side has a convex surface, as shown in FIG. 2. Such an irregular joint surface enlarges the area of the joint surface to achieve higher peel strength (unit: N/mm). In addition, force can be easily transferred from the high-hardness supporting elastic body to the low-hardness supporting elastic body. In this case, the height (h₂) of the lower high-hardness elastomer molded part corresponds to the height of the top of the convex portion. In other words, the height (h₁) of the upper low-hardness elastomer molded part corresponds to the height of the bottom of the concave portion.

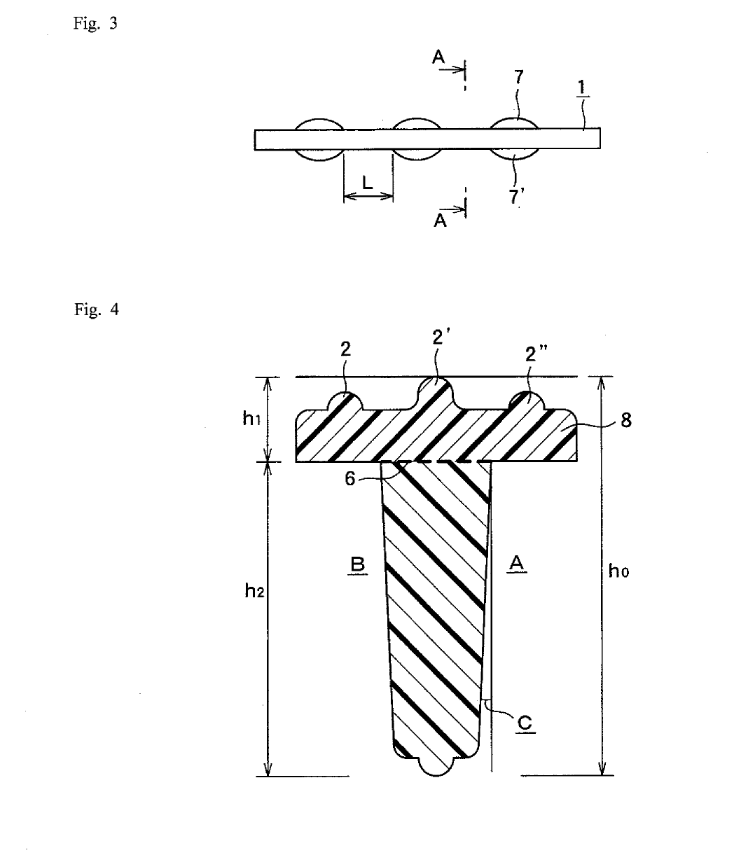

FIG. 3 is a partial plan view of the two-material composite annular gasket. Although the entire gasket is formed into an annular shape so as to fit the shape of a groove, the gasket is also applicable when there is no step groove. The sealing surface of the gasket may be provided with a plurality of projections, as with conventional gaskets. FIGS. 1 and 2 each show a cross-sectional view of the gasket taken along the A-A line in FIG. 3. Both side surfaces of the annular gasket 1 are each provided with a pair of projections 7 and 7′ at an interval L in a longitudinal direction. These pairs of projections are convex portions for preventing the gasket from falling or removing. Such convex portions are optionally provided.

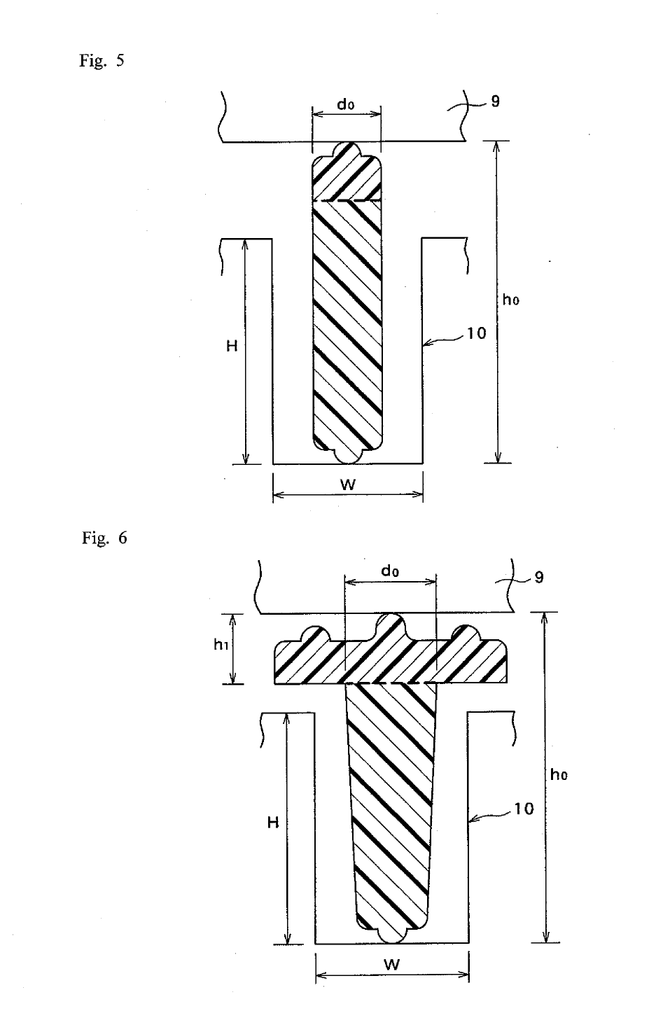

FIG. 4 shows a longitudinal cross-sectional view of another two-material composite annular gasket having a different cross-sectional shape. More specifically, the upper low-hardness elastomer molded part in the form shown in FIG. 1 or 2 projects to both sides to form an overhang portion 8, which is provided with upper projections 2, 2′, and 2″. The overhang portion is designed to be held between two surfaces so as to further stabilize the insertion state of the gasket. Although the overhang portion is held between two surfaces, the projections provided in the overhang portion are configured to abut on the surface of the opposing housing, preventing increase in reaction force and achieving high surface pressure. In order to achieve the reaction force characteristics of the high-hardness elastomer molded part, the high-hardness elastomer molded part is preferably configured to have a cross-section having inclined surfaces on both sides so that the width of the cross-section becomes narrower toward the lower edge. Sign C indicates a taper angle.

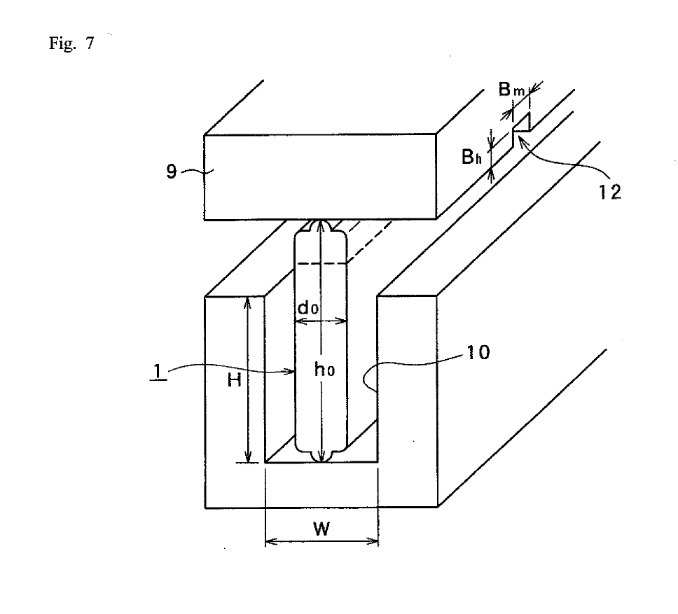

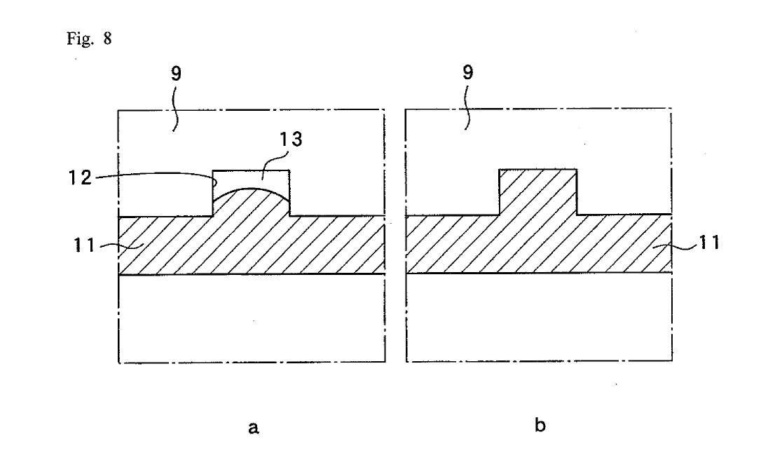

FIGS. 5 and 6 are cross-sectional views respectively showing insertion states of the two-material composite annular gaskets shown in FIGS. 1 and 4. Sign 9 indicates a housing, and Sign 10 indicates an insertion groove. Moreover, FIG. 7 is a perspective view showing a state of the two-material composite annular gasket 1 of the present invention inserted in the insertion groove 10 of a member to be fixed with the housing having a gap portion 12. Furthermore, FIG. 8 shows cross-sectional views indicating a leakage state (a) and a hermetical sealed state (b) when the gasket 11 is inserted in the gap portion 12.

The two-material composite annular gasket of the present invention is suitably used for three-surface simultaneous sealing of a gap formed by mating surfaces of three members. More specifically, the gasket is held between two opposing surfaces, i.e., the unsealed surface of two members sealed to each other by a sealing material and the surface of another member, one of the surfaces having a gasket insertion groove, and the other opposite surface having a concave gap portion positioned across the insertion groove. The high-hardness elastomer molded part side of the gasket is inserted in the insertion groove. The low-hardness elastomer molded part side of the gasket is brought into contact with the other opposite surface having the gap portion and deformed, so that the gap portion is hermetically coupled with the low-hardness elastomer molded part.

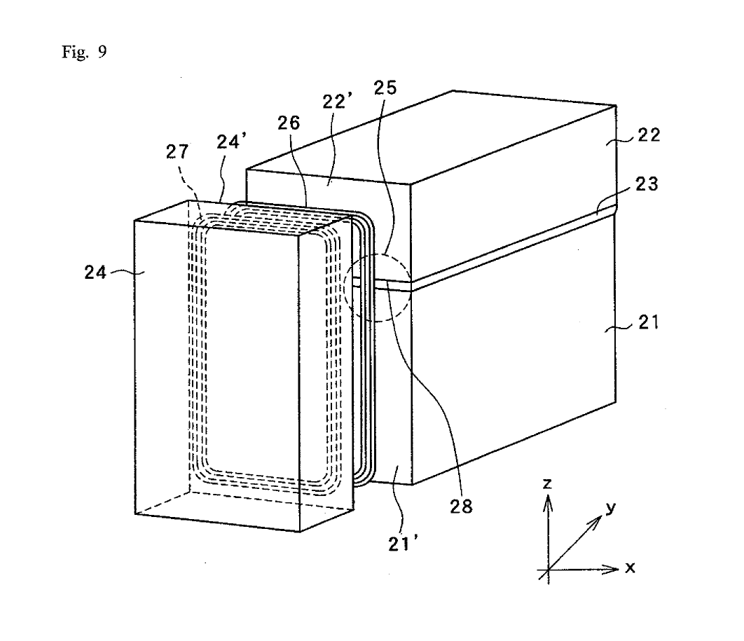

For example, referring to FIG. 9, two members 21 and 22 are sealed to each other by a sealing material 23. A gasket 26 is held between two opposing surfaces, i.e., the surfaces 21′ and 22′ of the two members to be sealed and the surface 24′ of another member 24 to be simultaneously sealed. The surface 24′ has a gasket insertion groove 27, and the other opposite surfaces 21′ and 22′ have a concave gap portion 28 formed by the two members 21 and 22 and a sealing material 23 in the position across the insertion groove 27. The high-hardness elastomer molded part side of the gasket is inserted in the insertion groove 27. The low hardness elastomer molded part side of the gasket is brought into contact with the other opposite surface having the gap portion and deformed, so that the gap portion is hermetically coupled with the low-hardness elastomer molded part. Thus, the two-material composite annular gasket of the present invention is used for three-surface simultaneous sealing of a gap formed by mating surfaces of three members.

In this case, the volume of the low-hardness elastomer molded part must be set larger than the volume of the gap (gap formed by three mating surfaces) to be subjected to three-surface simultaneous sealing.

### Example

The following describes the present invention with reference to an Example.

### Example

A T-shaped, tapered and annular gasket having the cross-sectional shape shown in FIG. 4 was used in the manner shown in FIG. 7 to perform sealing. The low-hardness elastomer molded part (height h₁=1.5 mm) of the gasket was formed of acrylic rubber having a Shore A hardness of 10, and the high-hardness elastomer molded part (height h₂=6.45 mm) was formed of acrylic rubber having a Shore A hardness of 50. The height h₀ of the entire gasket was 7.95 mm, and the height h₁/h₀ was thus 18.9%. The width d₀ of the parting line was 2.17 mm, and the taper angle (C) was 2.0°.

In the embodiment shown in FIG. 7, the two-material composite annular gasket was inserted in an insertion groove at a right angle to a housing having a gap portion 12 (gap height Bₕ=1.0 mm, gap width Bₘ=0.6 mm). The gap area 13 (see FIG. 8) when the gasket was compressed at a compression rate of 25% or 30% was measured by a compression test. The leakage state indicates that there is a gap area, and the sealed state indicates that the gap area is 0.

The gap area was measured when the two-material composite annular gasket (Example) of the present embodiment and a conventional single-material gasket of the same form entirely formed of acrylic rubber having a Shore A hardness of 50 (Comparative Example) were used. The following table shows the obtained results.

TABLE

| Compression rate | Ex. | Comp. Ex. |
|---|---|---|
| 25% | 0.00 mm² | 0.22 mm² |
| 30% | 0.00 mm² | 0.15 mm² |

The above results demonstrate that the two-material composite annular gasket of the present invention has excellent gap-filling properties for the housing.

Incidentally, the gap area was measured in the following manner.

A putty was previously placed in a rectangular concave groove (a pseudo-gap portion) formed in a metal plate. When the metal plate, including the putty, was pressed to a gasket, the putty was extruded from the groove in a volume corresponding to the volume of the gasket material entering into the gap portion. Part of the putty remaining in the groove was cured as it was. After the putty was cured, a different colored putty was further poured into the groove and cured. The two-colored putties after curing were simultaneously removed from the groove, and cut at a right angle to the groove direction. The cross-sectional surface thereof was photographed, and the photograph was subjected to image processing. Then, the cross-sectional area of the initial putty that had remained in the rectangular part was measured as a gap area.

The two-material composite annular gasket of the present invention can be used, for example, as an engine gasket, as shown in FIG. 9, to enable three-surface simultaneous sealing in the intersection of mating surfaces of, for example, a cylinder block, a cylinder head, and a chain cover or a cam cover, namely a three-point sealing part.

### DESCRIPTION OF REFERENCE SIGNS AND NUMERALS

A Internal surface
B External surface
C Taper angle
1 Two-material composite annular gasket
2 Upper projection
3 Lower projection
4 Low-hardness elastomer molded part
5 High-hardness elastomer molded part
6 Parting line
7 Projection
8 Overhang portion
9 Housing
10 Insertion groove
11 Gasket
12 Gap portion
13 Gap area
21 Cylinder block
21′ Surface of the cylinder block to be sealed with a chain cover
22 Cylinder head
22′ Surface of the cylinder head to be sealed with the chain cover
23 Cylinder head gasket
24 Chain cover
24′ Surface to be simultaneously sealed
25 Three-point sealing part
26 Gasket
27 Groove for the gasket

1. A two-material composite gasket for sealing a gap between two opposing surfaces, one of the surfaces having a concave gap portion, which is to be sealed by the gasket,
the gasket having an oblong cross-sectional shape and having projections on a top end and a bottom end thereof;
the gasket including an upper low-hardness elastomer molded part formed of vulcanized rubber having a Shore A hardness of 5 to 35, a lower high-hardness elastomer molded part formed of vulcanized rubber having a Shore A hardness of 45 to 80, and a parting line bonding the low-hardness elastomer molded part and the high-hardness elastomer molded part, the parting line being positioned so that a height of the low-hardness elastomer molded part is 5 to 40% of a height of the entire gasket.

2. The two-material composite gasket according to claim 1, wherein the gasket for sealing a gap between two opposing surfaces is an annular gasket.

3. The two-material composite gasket according to claim 1, wherein a center of the top end of the gasket and a center of the bottom end of the gasket are each provided with a projection.

4. The two-material composite gasket according to claim 1, wherein the parting line bonding the low-hardness elastomer molded part and the high-hardness elastomer molded part is formed on a planar surface perpendicular to the upward and downward direction of the gasket.

5. The two-material composite gasket according to claim 1, wherein in the parting line bonding the low-hardness elastomer molded part and the high-hardness elastomer molded part, the low-hardness elastomer molded part is formed in a concave shape, and the high-hardness elastomer molded part is formed in a convex shape.

6. The two-material composite gasket according to claim 1, wherein the low-hardness elastomer molded part and the high-hardness elastomer molded part are bonded to each other by vulcanization bonding.

7. The two-material composite gasket according to claim 1, wherein the low-hardness elastomer molded part projects outward sideways to form an overhang portion, which is provided with a plurality of projections.

8. The two-material composite gasket according to claim 1, wherein the high-hardness molded part is configured to have a cross-section having inclined surfaces on opposite sides so that the width of the cross-section becomes narrower toward the lower edge.

9. The two-material composite gasket according to claim 1, wherein the gap between the surfaces, one surface of which has a gap portion, is formed by a plurality of members in contact with each other.

10. The two-material composite gasket according to claim 9, which is used for three-surface simultaneous sealing of a gap formed by mating surfaces of three members.

11. The two-material composite gasket according to claim 10, which is used for three-surface simultaneous sealing of a gap formed by matting surfaces of three members, the gasket being held and inserted between two opposing surfaces, which is an unsealed surface of two members that are sealed to each other by a sealing material, and an opposing surface of another member; wherein
one of the surfaces has a gasket insertion groove,
the other opposite surface has a concave gap portion positioned across the insertion groove,
the high-hardness elastomer molded part side of the gasket is inserted in the insertion groove,
the low-hardness elastomer molded part side of the gasket is brought into contact with the other opposite surface having the gap portion and deformed, so that the gap portion is hermetically bonded with the low-hardness elastomer molded part.

12. The two-material composite gasket according to claim 10, wherein the volume of the low-hardness elastomer molded part is set larger than the volume of a gap to be subjected to three-surface simultaneous sealing.

13. The two-material composite gasket according to claim 10, which is used for three-surface simultaneous sealing of a gap of a joint structure composed of three members comprising a cylinder block, a cylinder head, and a chain cover of an automobile engine.

14. The two-material composite gasket according to claim 2, wherein a center of the top end of the gasket and a center of the bottom end of the gasket are each provided with a projection.

15. The two-material composite gasket according to claim 7, wherein the high-hardness molded part is configured to have a cross-section having inclined surfaces on opposite sides so that the width of the cross-section becomes narrower toward the lower edge.

16. The two-material composite gasket according to claim 11, wherein the volume of the low-hardness elastomer molded part is set larger than the volume of a gap to be subjected to three-surface simultaneous sealing.
